(19) United States
(12) Patent Application Publication
(10) Pub. No.: US 2025/0032999 A1
(43) Pub. Date: Jan. 30, 2025

(54) Thermal Lamination of Cellulose Substrate with ePTFE Membrane

(71) Applicant: Parker-Hannifin Corporation, Cleveland, OH (US)

(72) Inventors: Jarod A. Lake, Prairie Village, KS (US); Dale R. Kadavy, Overland Park, KS (US)

(73) Assignee: Parker-Hannifin Corporation, Cleveland, OH (US)

(21) Appl. No.: 18/912,304

(22) Filed: Oct. 10, 2024

Related U.S. Application Data
(63) Continuation of application No. PCT/US2023/012387, filed on Feb. 6, 2023.
(60) Provisional application No. 63/405,951, filed on Sep. 13, 2022.
(60) Provisional application No. 63/332,413, filed on Apr. 19, 2022.

(51) Int. Cl. B01D 69/10; B01D 63/14; B01D 67/00; B01D 69/02; B01D 71/36

(52) U.S. Cl. CPC B01D 69/107; B01D 63/14; B01D 67/0002; B01D 69/02; B01D 71/36; B01D 2325/20

(57) ABSTRACT

A filter media that includes a substrate layer, which includes a sheet having a fibrous polyester and cellulose blend with less than 80% polyester fibers by weight. The sheet further includes a membrane layer that is made from ePTFE. The membrane layer is thermally laminated to the one side of the substrate layer. In particular embodiments, the filter media can be pleated into a filter element that has more than five pleats per inch.

### CROSS-REFERENCE TO RELATED PATENT APPLICATIONS

This patent application is a continuation of U.S. PCT Patent Application No. PCT/US2023/012387, filed Feb. 6, 2023, which is now pending, which claims the benefit of U.S. Provisional Patent Application No. 63/405,951, filed Sep. 13, 2022, and claims the benefit of U.S. Provisional Patent Application No. 63/332,413, filed Apr. 19, 2022, the entire teachings and disclosures of which are incorporated herein by reference thereto.

### FIELD OF THE INVENTION

This invention generally relates to a filter media, and more particularly to a media to be used in a pleated filter element.

### BACKGROUND OF THE INVENTION

Typically, the efficiency rating of cellulose media is MERV 8. However, because of its light weight, low cost, and good pleatability, cellulose media is widely used in industrial filtration applications. Nanofibers can be added to cellulose media to improve the efficiency rating to MERV 15, but the durability of the nanofibers can be a drawback in some applications. Spunbond polyester media also typically has a MERV 10 efficiency rating. However, spunbond polyester has additional options such as polytetrafluoroethylene (PTFE) or expanded polytetrafluoroethylene (ePTFE) membrane lamination. PTFE laminated spunbond polyester can have an efficiency rating of MERV 16 or even MERV 17. But PTFE laminated spunbond polyester has a higher cost than cellulose media and does not share the same pleat performance. For example, cellulose media can have 12 pleats per inch (typical industry max) and spunbond polyester can only have five pleats per inch (again typically an industry max).

Some conventional filter elements include expanded polytetrafluoroethylene (ePTFE) within their blend. There are also some conventional filter elements which have a three-layer laminated media where a middle layer of a bicomponent polyester media is acting as a glue in the lamination. But this arrangement tends to be more costly than other types of filter elements, as PTFE fibers are typically much more costly than polyester or cellulose. In addition, using a melting layer of a binder layer or a bicomponent polyester layer can reduce the pleatability of the final product. Additionally, due to the melting/utilization of a binder layer, such as polyvinyl acetate, the binder layer can close off pores of the substrate leading to a lower air permeability, and preventing the utilization of a high-efficiency particulate air or high-efficiency particulate absorbing (HEPA) membrane, as air will not be able to flow through the filter in a manner that is sufficient for many applications.

HEPA filters, as defined by the United States Department of Energy (DOE) standard adopted by most American industries, remove at least 99.97% of aerosols 0.3 micrometers (μm) in diameter. The HEPA-grade filter's minimal resistance to airflow, or pressure drop, is usually specified around 300 pascals (0.044 psi) at its nominal volumetric flow rate. The diameter specification of 0.3 microns responds to the worst case; the most penetrating particle size (MPPS). Particles that are larger or smaller are trapped with even higher efficiency. Using the worst-case particle size results in the worst-case efficiency rating (i.e., 99.97% or better for all particle sizes).

It is also known that a filter media can have three layers that include a base media, an expanded polytetrafluoroethylene (ePTFE) membrane, and a third layer that is an electrically charged nonwoven meltblown layer. U.S. Pat. No. 8,262,780, issued to Smithies et al., discloses a composite filter using membrane filter media for use in a gas turbine inlet, while U.S. Pat. No. 7,115,151, issued to Smithies et al., discloses a high-efficiency particulate air rated vacuum bag media and associated method of production, the entire teachings and disclosures of which are incorporated herein by reference thereto.

Embodiments of the present invention provide a filter media and element that addresses some of the problems outlined above. These and other advantages of the invention, as well as additional inventive features, will be apparent from the description of the invention provided herein.

### BRIEF SUMMARY OF THE INVENTION

In one aspect, embodiments of the invention provide a filter media that includes a substrate layer, which comprises a sheet having a fibrous polyester and cellulose blend with less than 80% polyester fibers by weight. It is envisioned that, in alternate embodiments, the fibrous polyester and cellulose blend may have as little as 20% polyester fibers by weight. The sheet further includes a membrane layer that is made from ePTFE. The membrane layer is thermally laminated to the one side of the substrate layer. In the context of this application, the substrate layer and the membrane layer are both configured as sheets having two sides. One side of the substrate layer is laminated to one side of the membrane layer. The second side of the substrate layer is exposed, as is the second side of the membrane layer. These second sides face in opposite directions when the filter media is flat and unpleated. The filter media allows for the creation of a pleated filter element with more than five pleats per inch. In certain embodiments, the filter media has at least eight pleats per inch, while in more particular embodiments, the filter media has at least 12 pleats per inch.

In certain embodiments, the filter media includes a binder resin impregnated in the substrate layer. In more particular aspects, the binder resin is a phenolic or latex polymer resin. In other aspects, the binder resin is flame retardant. In a further aspect, the polyester and cellulose fibers make up at least 60% of the substrate layer volume. Additionally, the binder resin makes up no more than 40% of the substrate layer volume.

The substrate layer may have a flame-retardant coating. In some embodiments, a majority of the polyester fibers are disposed to one side of the substrate layer sheet. In similar aspects, a majority of the cellulose fibers are disposed to the other side of the substrate layer sheet opposite the one side. In certain embodiments, the filter media has at least 12 pleats per inch.

The substrate layer may further include a sheet having a fibrous polyester and cellulose blend with more than 20% cellulose fibers by weight. It is envisioned that, in alternate embodiments, the fibrous polyester and cellulose blend may have as much as 80% cellulose fibers by weight. In a more particular aspect, the substrate layer has a blend of 50% polyester fibers and 50% cellulose fibers. In a further aspect, the substrate layer has a weight greater than 75 grams per square meter. In alternate embodiments, the substrate layer has a weight greater than 75 grams per square meter, and as much as 285 grams per square meter. In other examples, the substrate layer and membrane layer are configured such that the resulting pleatable media has an air permeability greater than 2.5 cubic feet per minute.

In another aspect, embodiments of the invention provide a method for making a filter media. The method includes the step of fabricating a substrate layer comprising a blend of polyester and cellulose fibers. The blend has less than 80% polyester fibers by weight. It is envisioned that, in alternate embodiments, the fibrous polyester and cellulose blend may have as little as 20% polyester fibers by weight. The method also includes thermally laminating an ePTFE membrane layer, which may be a HEPA-grade ePTFE, to one side of the substrate layer. The thermal lamination described may be performed without any adhesives. The method may further include pleating the laminated membrane layer and substrate layer.

The method may also include the step of impregnating the substrate layer with a resin binder. In more particular embodiments, the method calls for impregnating the substrate layer with a phenolic or latex resin binder. In other aspects, the method requires impregnating the substrate layer with a flame retardant resin binder. Furthermore, coating the substrate layer may also be done with a flame retardant material.

In some aspects, the method includes fabricating the substrate layer with a majority of the polyester fibers disposed toward one side of the substrate layer. The method may also include fabricating the substrate layer with a majority of the cellulose fibers toward another side of the substrate layer opposite the one side. In a further aspect, the method calls for fabricating the substrate layer such that the polyester and cellulose fibers make up at least 60% of the substrate layer volume. Embodiments of the method may also include wet-laying the blend of polyester and cellulose fibers.

In a particular aspect, the method requires forming more than five pleats per inch in the laminated membrane layer and substrate layer. In another aspect, the method calls for forming at least eight pleats per inch, while in other embodiments, the method calls for forming at least twelve pleats per inch in the laminated membrane layer and substrate layer. Certain aspects of the method include fabricating a substrate layer in which the blend has more than 20% cellulose fibers. It is envisioned that, in alternate embodiments, the fibrous polyester and cellulose blend may have as much as 80% cellulose fibers by weight. Other aspects of the method call for fabricating a substrate layer that weighs more than 95 grams per square meter. The method may further include configuring the substrate layer and membrane layer such that the resulting filter media has an air permeability greater than 2.5 cubic feet per minute.

The proposed laminate addresses at least some of the issues surrounding cellulose and of spunbond polyester. A cellulose polyester blended wet-laid media can be pleated to 12 or more pleats per inch, at a weight similar to cellulose, at a cost less than spunbond polyester, and is laminated with an ePTFE membrane raising efficiency of the final filter. The resulting filter media and filter element is suitable for a variety of uses, such as in welding or spark-rich environments due to the flame retardant properties of the substrate layer, in addition to the HEPA filtration from the membrane layer.

According to one aspect, a cellulose and polyester (polyethylene terephthalate (PET)) wet-laid blend base substrate layer is thermally laminated with an ePTFE (expanded polytetrafluoroethylene) membrane layer. This wet-laid media may or may not utilize a phenolic or latex polymer resin to provide pleatability. The substrate layer 102 can have a majority of the polyester fibers propagated to one side to facilitate membrane lamination. The ePTFE membrane will allow higher levels of filtration with the handling capabilities of cellulose—equating to more filtration area at a lower cost than polyester-only alternatives. Due to the natural burn resistant properties of ePTFE, applying a flame-retardant coating to the base substrate provides the ideal media for welding, spark, and other smoke applications.

The substrate layer has a fiber blend composed of polyester fiber concentrations of less than 80% and cellulose fiber concentration greater than 20%. The weights of the substrate are greater than 95 grams per square meter, with a final laminated media with air permeability greater than 2.5 cubic feet per minute. This includes final laminates with an ePTFE membrane layer, which may be HEPA grade.

The cellulose and polyester fibers make up a minimum of 60% of the volume of the substrate material. The fibers are arranged such that the majority of cellulose fibers are on one side of the substrate and the majority of the polyester fibers are on the other. The resin used as a stiffening compound makes up the remainder of the substrate volume and is applied to one or both sides of the material. The resin can have flame-retardant properties to provide deflagration protection of the filter components. The resin could also be absent from the wet laid media construction.

The polyester fibers within the wet-laid media are the primary aid for thermal lamination with the ePTFE layer. By lowering the number of polyester fibers in the substrate, the air permeability of the final laminate is higher than if the same process was done with a higher blend, as the polyester fibers will melt and block the pores, impeding air flow. But by using a lower concentration of polyester fibers, the higher the air permeability leads to lower changes in pressure across the filter media. Lower pressure change relates to savings by the end user by reducing power consumption.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective view of a section of thermally-laminated filter media, constructed in accordance with an embodiment of the invention;

FIG. 2 is a perspective view of the thermally-laminated filter media of FIG. 1 after pleating of the media;

FIG. 3 is an enlarged perspective view of the thermally-laminated filter media showing a non-uniform distribution of polyester and cellulose fibers, according to an embodiment of the invention; and

FIG. 4 is an exemplary embodiment of a pleated filter element using the thermally-laminated filter media of FIG. 1.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

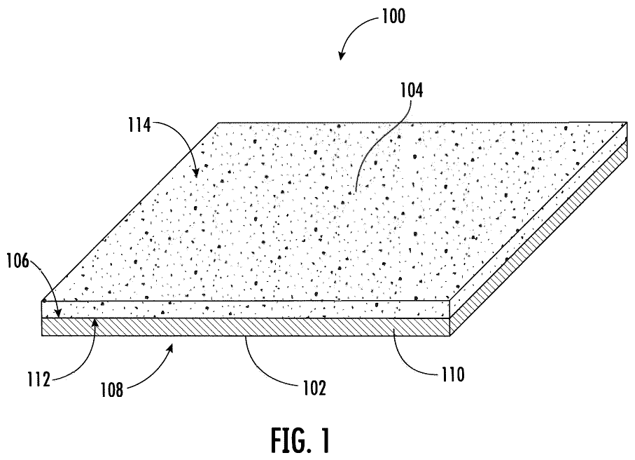

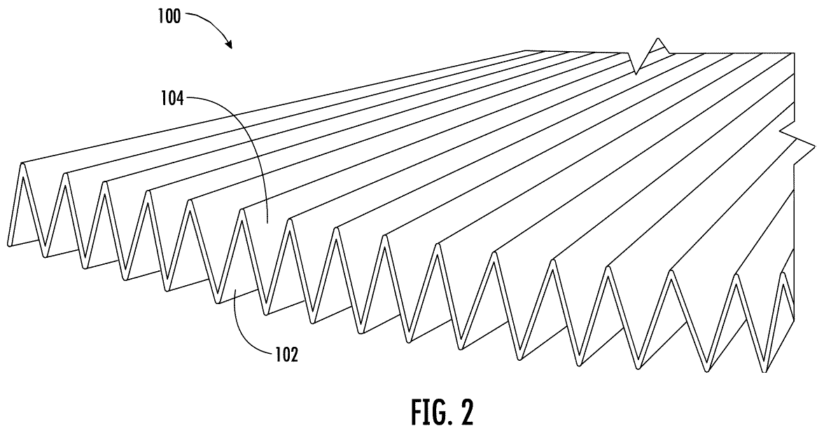

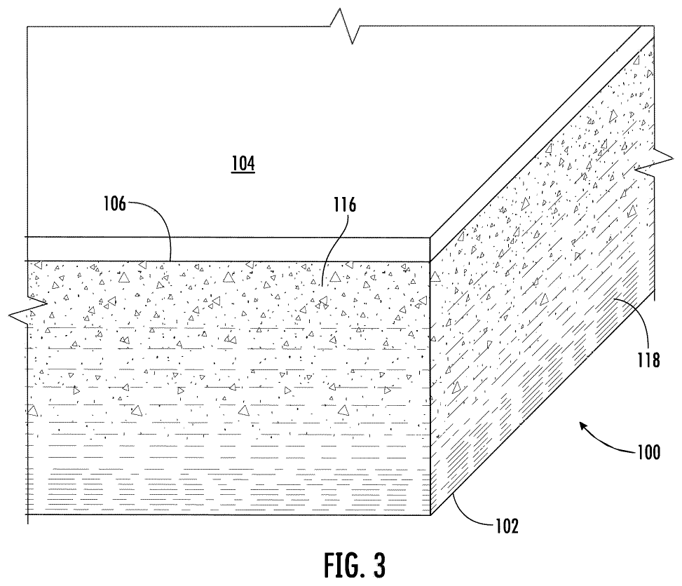

FIG. 1 is a perspective view of a thermally-laminated filter media 100, constructed in accordance with an embodiment of the invention, while FIG. 2 is a perspective view of the thermally-laminated filter media of FIG. 1 after pleating of the media. In the embodiment shown, the filter media 100 includes a substrate layer 102, with a gradient of polyester fibers 116 and cellulose fibers 118 (see FIG. 3), though alternate production processes are envisioned. The substrate layer 102 is combined with a membrane layer 104 via thermal lamination. The polyester could have a core-sheath structure in some aspects. In certain aspects, embodiments of the invention may include other forms of polybutylene terephthalate (PBT) or polyethylene terephthalate (PET) fibers. In particular embodiments, the substrate layer 102 is a single blend deposition. In an alternate embodiment, polypropylene may be used in place of, or in addition to, the polyester to provide similar ability for thermal lamination of substrate and membrane layers 102, 104.

The substrate layer 102 may have a flame-retardant coating. In some embodiments, a majority of the polyester fibers 116 (see FIG. 3) are disposed to one side 106 of the sheet that makes up the substrate layer 102. In similar aspects, a majority of the cellulose fibers 118 are disposed to the other side 108 of the substrate layer sheet 102 opposite the one side 106. In certain aspects, the filter media 100 has at least eight pleats per inch, while in other embodiments, the filter media 100 has at least 12 pleats per inch.

The substrate layer 102 has a fiber blend composed of polyester fiber concentrations of less than 80% and cellulose fiber concentration greater than 20%. As also explained above, in alternate embodiments, the fibrous polyester and cellulose blend may have as much as 80% cellulose fibers 118 by weight, and may have as little as 20% polyester fibers 116 by weight. The substrate layer blend concentration percentages cited above are before the addition of any optional binder resins or fire-retardant coatings. In certain aspects, the weight of the substrate layer 102 is greater than 75 grams per square meter, with a final laminated filter media 100 with air permeability greater than 2.5 cubic feet per minute. This includes final laminates with HEPA-grade ePTFE membrane layer 104 as well.

The cellulose fibers 118 and polyester fibers 116 make up a minimum of 60% of the volume of the substrate layer 102. In a particular example, the blended fibers are arranged such that the majority of polyester fibers 116 are on one side 106 of the substrate layer 102 and the majority of the cellulose fibers 118 are on the other side 108 of the substrate layer 102. FIG. 3 is an enlarged perspective view of the thermally-laminated filter media 100 showing a non-uniform distribution of polyester fibers 116 and cellulose fibers 118, according to an embodiment of the invention. As can be seen from the example of FIG. 3, most of the polyester fibers 116 are on the first side 106 of the substrate layer 102 laminated to the membrane layer 104, while most of the cellulose fibers 108 are on the other side 114 of the substrate layer 102 opposite the first side 106. Fabricating such a substrate layer 102 may involve successively laying down fibers with different ratios of polyester to cellulose, then wet laying all of the fibers with a resin binder such that the varying ratios of polyester to cellulose are maintained in the way that they were first laid down.

A binder resin 110, used as a stiffening compound, makes up the remainder (i.e., 40% or less) of the substrate volume and may be applied to one or both sides 106, 108 of the substrate layer 102 material. The binder resin 110 can have flame-retardant properties to provide deflagration protection of the filter components. The resin 110 could also be absent from the wet laid construction of the substrate layer 102.

In certain aspects of the invention, the thermally-laminated filter media 100 includes the substrate layer 102 having a sheet of fibrous polyester and cellulose blend of less than 80% polyester fibers 116 by weight. As explained above, in alternate embodiments, the fibrous polyester and cellulose blend may have as little as 20% polyester fibers 116 by weight. The substrate layer 102 may include a sheet having a fibrous polyester and cellulose blend of more than 20% cellulose fibers 118. As also explained above, in alternate embodiments, the fibrous polyester and cellulose blend may have as much as 80% cellulose fibers 118 by weight.

The substrate layer blend concentration percentages cited above are before the addition of any optional binder resins or fire-retardant coatings. However, one of ordinary skill will recognize that embodiments with various ratios of polyester fibers 116 to cellulose fibers 118 are within the scope of the present invention. In a more particular aspect, the substrate layer 102 has a blend of 50% polyester fibers 116 and 50% cellulose fibers 118. In another example, the substrate layer 102 has a weight greater than 75 grams per square meter. In alternate embodiments, the substrate layer has a weight greater than 75 grams per square meter, and as much as 285 grams per square meter.

In other aspects, the substrate layer 102 and membrane layer 104 are configured such that the filter media has an air permeability greater than 2.5 cubic feet per minute. However, it is envisioned that alternate aspects of the invention may have an air permeability lower than 2.5 cubic feet per minute, and may have substrate layers 102 that weigh less than 75 grams per square meter.

In certain aspects, the filter media includes a binder resin 110 impregnated in the substrate layer 102. In more particular aspects, the binder resin 110 is a phenolic or latex polymer resin 110. In other aspects, the binder resin 110 is flame retardant. In a further aspect, the polyester fibers 116 and cellulose fibers 118 make up at least 60% of the substrate layer volume. Additionally, the binder resin 110 makes up no more than 40% of the substrate layer volume.

The membrane layer 104 may be made from ePTFE. In a particular example, the membrane layer 104 is thermally laminated to the one side 106 of the substrate layer 102.

As explained above, in the context of this application, the substrate layer 102 and the membrane layer 104 are both configured as sheets having two sides. One side 106 of the substrate layer 102 is laminated to one side 112 of the membrane layer 104. The second side 108 of the substrate layer 102 is exposed, as is the second side 114 of the membrane layer 104. These second sides 108, 114 of the two layers 102, 104 face in opposite directions, i.e., 180 degrees apart, when the filter media 100 is flat and unpleated. The filter media 100 is pleated and has more than five pleats per inch.

In a particular aspect, the membrane layer 104 is made from an expanded micro porous polytetrafluoroethylene (ePTFE) membrane. The ePTFE membrane in the membrane layer 104, in one example, has a basis weight of 0.50 to 25 g/m², in another aspect around 5 g/m². The mean pore size of the membrane layer 104 can range from 0.1 to 10 microns, but in another aspect, the mean pore size can be approximately one micron. The air permeability of the membrane layer 104, before a lamination process is performed, can range from 0.25 to 45 cubic feet per minute (cfm) at 0.5″ of water pressure, but in a specific embodiment is around 10 cfm at 0.5″ water pressure.

The membrane of the membrane layer 104 is thermally laminated via a heat and pressure process to melt the polyester fibers 116 of the base substrate 102 into the microporous membrane of the membrane layer 104. During lamination, the membrane, of the membrane layer 104, becomes fixed to the substrate layer 102. The ePTFE in the membrane layer 104 is durable enough to withstand the rigors of further processing, as well as the end use application in the composite media. During the lamination process, the air permeability property of the membrane, of the membrane layer 104, changes as the air permeability of the membrane of the membrane layer 104 is reduced by the melting of the fibers into the membrane layer 104. The mechanical anchoring of the thermoplastic polyester fibers 116 into the pores of the membrane, in the membrane layer 104, blocks off air flow with a resultant air permeability of the filter media 100 being reduced to around 2.5 cfm at 0.5 inches of water pressure.

After the membrane layer 104 has been laminated on the substrate layer 102, the combination of the membrane layer 104 and the substrate layer 102 provides for a durable three-dimensional composite filtration layer, which has an extensive multi-layer tortuous path that permits high efficiency and fine particle capture without substantially restricting air flow or increasing pressure drop. The multi-layer tortuous path may include a complex arrangement of small pores in the filter media. Such structure has been found to be extremely durable against the mechanical forces in a pulsed filtration system, for example, especially in comparison to a two-dimensional nanofiber layer with minimal thickness.

In an exemplary embodiment, the schematic illustration of FIG. 1 shows the sheet-like construction of the composite filter media 100. As can be seen, the filter media 100 includes the substrate layer 102 and the membrane layer 104. The substrate layer 102 has the first side 106 and the second side 108. In one aspect, the membrane layer 104 is deposited onto the first side 106 of the substrate layer 102. Although not explicitly shown in the illustration of FIG. 1, one of ordinary skill in the art will recognize that the membrane layer 104 could be deposited onto the second side 108 or that, in a further aspect, the membrane layer 104 could be deposited on each of first and second sides 106 and 108.

The substrate layer 102 and the membrane layer 104 combine to attain the HEPA-grade filtration efficiency performance for an average most penetrating particle size of approximately 0.2 to 0.4 microns. In one specific example, the substrate layer 102 and the membrane layer 104 combine to attain the HEPA-grade filtration efficiency performance for an average most penetrating particle size of 0.3 microns. Based upon the multi-layer tortuous path of the membrane pore structure combined with the substrate layer 102, a filtration efficiency greater than or equal to 99.97% is achieved, in one example, for particles having an average diameter of 0.3 microns at a volumetric air flow rate of 533 cm³/sec or 1.13 cubic feet per minute (cfm).

The thermally-laminated filter media 100 provides for a lower pressure drop build-up because of less deflection of the filter media from the forces exerted on the filter media 100 during the filtering and reverse cleaning operations. Also, the pleated substrate layer 102 tends to be more efficient than known filter media substrates at an equivalent or lower pressure drop. The substrate layer 102 provides bonding to consolidate fibers into a fabric or fabric substrate. In one aspect, the blended fibers used to form the substrate layer 102 can be finer than fibers used to form conventional filter media. In addition, the adherence bond between the substrate layer 102 and the membrane layer 104 may be enhanced due to additional thermal processing during a pleating or embossing operation.

Furthermore, an aspect of the invention provides for a method for making the filter media 100. The method includes the step of fabricating the substrate layer 102 which has a blend of polyester fibers 116 and cellulose fibers 118. The blend has less than 80% polyester fibers 116 by weight. As explained above, in alternate embodiments, the fibrous polyester and cellulose blend may have as little as 20% polyester fibers 116 by weight. The method also includes thermally laminating the ePTFE membrane layer 104 to one side 106 of the substrate layer 102. In particular embodiments, the ePTFE membrane layer 104 is a HEPA-grade membrane layer. The method may include thermally laminating the membrane layer 104 to the first side 106 of the substrate layer 102, to the second side 108 of the substrate layer 102, or to both sides 106, 108 of the substrate layer 102. The thermal lamination of the membrane layer 104 to the substrate layer 102 may be performed without the use of adhesives.

The method further includes pleating the laminated membrane layer 104 and substrate layer 102. The method may also include the step of impregnating the substrate layer 102 with a binder resin 110. In more particular aspects, the method calls for impregnating the substrate layer 102 with a phenolic or latex binder resin 110. In other aspects, the method requires impregnating the substrate layer 102 with a flame retardant binder resin 110. Furthermore, coating the substrate layer 102 may also be done with a flame retardant material.

In certain aspects, the method includes fabricating the substrate layer 102 with the majority of the polyester fibers 116 disposed toward one side 106 of the substrate layer 102. Thermal lamination of membrane layer 104 is carried out on the side 106 of the substrate layer 102 with the majority of the polyester fibers 116. The method may also include fabricating the substrate layer 102 with a majority of the cellulose fibers 118 toward another side 108 of the substrate layer 102 opposite the one side 106. In a further embodiment, the method calls for fabricating the substrate layer 102 such that the polyester fibers 116 and cellulose fibers 118 make up at least 60% of the substrate layer volume. Embodiments of the method may also include wet-laying the blend of polyester fibers 116 and cellulose fibers 118.

The thermally-laminated filter media 100 of the present invention addresses at least some of the above-described issues surrounding cellulose and of spunbond polyester. A standard 80/20 cellulose polyester blended wet-laid media can be pleated to 12 or more pleats per inch. Embodiments of the present invention at a weight similar to cellulose, at a cost less than solely spunbond polyester, and is laminated with an ePTFE membrane that can be pleated in a fashion similar to the aforementioned standard 80/20 cellulose polyester, i.e., 12 or more pleats per inch. Wet laying is a technique for the production of nonwoven fibers that utilizes short natural cellulosic fibers and their blends. Typically, other techniques for the production of nonwoven fibers involve chemicals and may call for a specific length of fibers for processing into nonwoven.

In the wet-laid process, staple fibers, of up to 12 millimeters in length and usually combined with viscose or wood pulp, are suspended in water. Afterwards the water-fiber-dispersion is pumped and continuously deposited on a forming wire. The steps involved in conventional wet laying usually include dispersion, deposition, and consolidation. Uniform dispersion is needed in order to achieve a wet laid material that is relatively free of defects. The quality of the dispersion depends on material parameters such as fiber length, surfactant, nature of the fibers, the linear density of the fibers, and certain machine parameters such as dispersion time and mechanical agitation.

In a particular embodiment, the method requires forming more than five pleats per inch in the laminated membrane layer 104 and substrate layer 102. In another embodiment, the method calls for forming at least twelve pleats per inch in the laminated membrane layer 104 and substrate layer 102. Certain embodiments of the method include fabricating a substrate layer 102 in which the blend has more than 20% cellulose fibers 118. As explained above, in alternate embodiments, the fibrous polyester and cellulose blend may have as much as 80% cellulose fibers 118 by weight. Other embodiments of the method call for fabricating a substrate layer 102 that weighs more than 75 grams per square meter. The method may further include configuring the substrate layer 102 and membrane layer 104 such that the pleated filter media 100 has an air permeability greater than 2.5 cubic feet per minute.

As explained above, in certain embodiments of the invention, a cellulose and polyester (polyethylene terephthalate (PET)) wet-laid blend base substrate layer 102 is thermally laminated with an ePTFE (expanded polytetrafluoroethylene) membrane layer 104. Similarly, in alternate embodiments of the invention, a cellulose and polyester (polybutylene terephthalate (PBT)) wet-laid blend base substrate layer 102 is thermally laminated with an ePTFE (expanded polytetrafluoroethylene) membrane layer 104. This wet-laid media may or may not utilize the aforementioned phenolic or latex polymer resin 110 to provide pleatability. As explained above, the substrate layer 102 can have a majority of the polyester fibers 116 propagated to one side 106 to facilitate thermal lamination with the membrane layer 104. The HEPA-grade membrane in the membrane layer 104 will allow filtration with the handling capabilities of cellulose—equating to more filtration area at a lower cost than polyester-only alternatives. Due to the natural burn resistant properties of ePTFE, applying a flame-retardant coating to the substrate layer 102 provides a suitable filter media and element for welding, spark, and other smoke applications.

The polyester fibers 116 within the wet-laid media are the primary aid for thermal lamination of the substrate layer 102 with the ePTFE in the membrane layer 104. By lowering the number of polyester fibers 116 in the substrate layer 102, the air permeability of the final laminate is higher than if the same process was done with a higher blend, as the polyester fibers 116 will melt and block the pores, impeding air flow. But by using a lower concentration of polyester fibers 116, the higher the air permeability leads to lower changes in pressure across the filter media 100. Lower pressure change relates to savings by the end user by reducing power consumption.

The thermally-laminated filter media 100, produced in accordance with the materials and processes required for the claimed invention, is suitable for use in welding or spark-rich environments due to the flame resistance that can be applied to the substrate layer 102, in addition to the HEPA filtration from the membrane layer 104 for fine filtration of smoke and fumes.

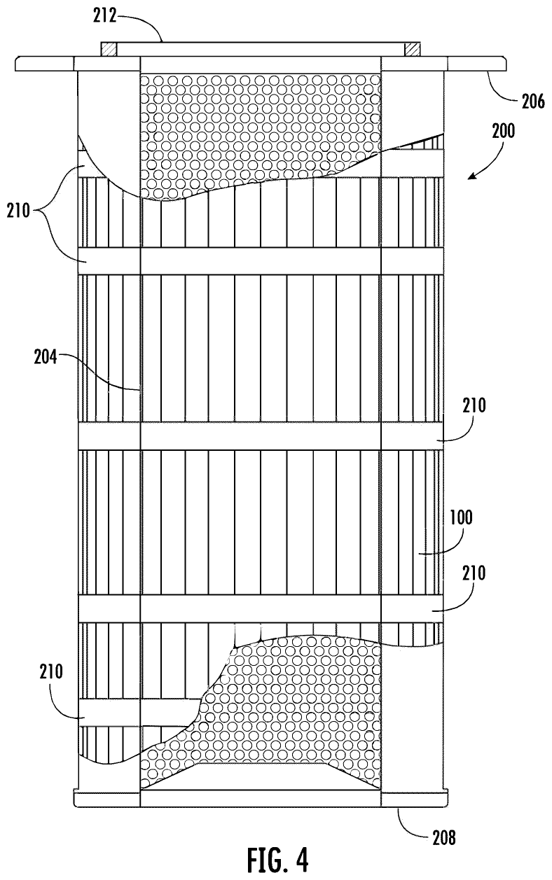

FIG. 4 shows an exemplary embodiment of a pleated filter element 200 using the thermally-laminated filter media 100. In the he pleated filter element 200, the filter media 100 is wrapped around a support screen 202 and the two ends of the media 100 are joined at a seam 204, and secured by one or more pleat stabilizing bands 210. The pleated filter element 200 includes a top end cap 206 and bottom end cap 208. A sealing gasket 212 is attached to the top end cap 206.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A filter media, comprising:
a substrate layer comprising:
a sheet having a fibrous polyester and cellulose blend with less than 80% polyester fibers by weight; and
a membrane layer made from ePTFE, the membrane layer being thermally laminated to the one side of the substrate layer.

2. The filter media as in claim 1, further comprising a binder resin impregnated in the substrate layer.

3. The filter media as in claim 2, wherein the binder resin is a phenolic or latex polymer resin.

4. The filter media as in claim 2, wherein the binder resin is flame retardant.

5. The filter media as in claim 2, wherein the polyester and cellulose fibers make up at least 60% of the substrate layer weight.

6. The filter media as in claim 5, wherein the binder resin makes up no more than 40% of the substrate layer weight.

7. The filter media as in claim 1, wherein the substrate layer has a flame-retardant coating.

8. The filter media as in claim 1, wherein a majority of the polyester fibers are disposed to one side of the substrate layer sheet.

9. The filter media as in claim 8, wherein a majority of the cellulose fibers are disposed to the other side of the substrate layer sheet opposite the one side.

10. The filter media as in claim 1, wherein the sheet has more than five pleats per inch.

11. The filter media as in claim 1, wherein the substrate layer comprises the sheet having a fibrous polyester and cellulose blend with more than 20% cellulose fibers.

12. The filter media as in claim 1, wherein the substrate layer has a weight greater than 75 grams per square meter.

13. The filter media as in claim 12, wherein the substrate layer has a weight less than 285 grams per square meter.

14. The filter media as in claim 1, wherein the substrate layer and membrane layer are configured such that the filter media has an air permeability greater than 2.5 cubic feet per minute.

15. The filter media as in claim 1, wherein the substrate layer comprises a blend of 50% polyester fibers and 50% cellulose fibers.

16. The filter media as in claim 1, wherein the substrate layer comprises a blend of 20% polyester fibers and 80% cellulose fibers.

17. The filter media as in claim 1, wherein the sheet has at least eight pleats per inch.

18. The filter media as in claim 1, wherein the sheet has at least 12 pleats per inch.

19. A method for making a filter media, the method comprising the steps of:
fabricating a substrate layer comprising a blend of polyester and cellulose fibers, the blend having less than 80% polyester fibers by weight; and
thermally laminating a membrane layer, made from ePTFE, to one side of the substrate layer.

20. The method of claim 19, further comprising the step of impregnating the substrate layer with a resin binder.

21. The method of claim 20, wherein impregnating the substrate layer with the resin binder comprises impregnating the substrate layer with a phenolic or latex resin binder.

22. The method of claim 20, wherein impregnating the substrate layer with the resin binder comprises impregnating the substrate layer with a flame retardant resin binder.

23. The method of claim 19, further comprising coating the substrate layer with a flame retardant material.

24. The method of claim 19, wherein fabricating the substrate layer comprises fabricating the substrate layer with a majority of the polyester fibers disposed toward one side of the substrate layer.

25. The method of claim 24, wherein fabricating the substrate layer comprises fabricating the substrate layer with a majority of the cellulose fibers toward another side of the substrate layer opposite the one side.

26. The method of claim 19, wherein fabricating the substrate layer comprises fabricating the substrate layer such that the polyester and cellulose fibers make up at least 60% of the substrate layer volume.

27. The method of claim 19, further comprising pleating the laminated membrane layer and substrate layer.

28. The method of claim 27, wherein pleating the laminated membrane layer and substrate layer comprises forming more than five pleats per inch in the laminated membrane layer and substrate layer.

29. The method of claim 27, wherein pleating the laminated membrane layer and substrate layer comprises forming at least twelve pleats per inch in the laminated membrane layer and substrate layer.

30. The method of claim 19, wherein fabricating a substrate layer comprises fabricating a substrate layer in which the blend has more than 20% cellulose fibers by weight.

31. The method of claim 19, wherein fabricating a substrate layer comprises fabricating a substrate layer that weighs more than 75 grams per square meter.

32. The method of claim 19, further comprising configuring the substrate layer and membrane layer such that the filter media has an air permeability greater than 2.5 cubic feet per minute.

33. The method of claim 19, wherein fabricating a substrate layer comprises wet-laying the blend of polyester and cellulose fibers.

34. The method of claim 19, wherein fabricating a substrate layer comprises fabricating a substrate layer comprising a blend of 50% polyester fibers and 50% cellulose fibers.

35. A filter media, comprising:
a. a substrate layer comprising a fibrous polyester and cellulose blend of less than 80% polyester fibers, where a majority of polyester fibers are disposed on one side of the substrate layer; and
b. a membrane layer comprising high-efficiency, HEPA-grade ePTFE, thermally laminated to the one side of the substrate layer.

36. The filter media as in claim 35, further including a binder resin impregnated in the substrate layer.

37. A method for making a filter media having a substrate layer comprising a fibrous polyester and cellulose blend of less than 80% polyester fibers, where the majority of polyester fibers are toward one side of the substrate layer, and a membrane layer comprising a high-efficiency HEPA-grade ePTFE, comprising the steps of:
i. thermally laminating the membrane layer to the one side of the substrate layer; and
ii. pleating the laminated membrane layer and substrate layer.

38. The method as in claim 37, further comprising the step of impregnating the substrate layer with a resin binder.
